(19) United States
(12) Patent Application Publication
(10) Pub. No.: US 2013/0307370 A1
(43) Pub. Date: Nov. 21, 2013

(54) ELECTROMECHANICAL CONVERTER, METHOD FOR PRODUCING SAME, AND USE THEREOF

(71) Applicants: Ludwig Jenninger, (US); Maria Jenninger, (US)

(72) Inventors: Werner Jenninger, Koln (DE); Joachim Wagner, Koln (DE); Deliani Lovera-Prieto, Bundde (NL); Dirk Schapeler, Mountain View, CA (US); Philippe Jean, Nice (FR)

(73) Assignee: BAYER INTELLECTUAL PROPERTY GMBH, Monheim (DE)

(21) Appl. No.: 13/805,789

(22) PCT Filed: Jun. 20, 2011
(86) PCT No.: PCT/EP2011/060225

§ 371 Date: Jun. 17, 2013

(30) Foreign Application Priority Data
Jun. 23, 2010 (EP) 10167012.3

(51) Int. Cl. H02N 1/08

(52) U.S. Cl. CPC H02N 1/08
USPC 310/300; 29/825

(57) ABSTRACT

The invention relates to an electromechanical converter, comprising at least one dielectric elastomer layer (1), electret layers (4, 5), and electrodes (2, 3), wherein the dielectric elastomer layer (1) is contacted by the at least one electret layer (4), the at least one electret layer (4) carries an electric charge and is contacted by a first electrode (2) and a second electrode (3) is arranged on the side of the dielectric elastomer layer (1) opposite the first electrode (2). The invention further relates to a method for producing same, to the use thereof, and to the generation of electrical energy in which the converter according to the invention can be applied. Operation of the converter for generating energy is possible in the planar mode (d₃₁ mode).

The present invention relates to an electromechanical converter. It relates further to a process for its production and to its use. The invention relates further to a method for obtaining electrical energy, in which the converter according to the invention can be used.

Electromechanical converters convert electrical energy into mechanical energy and vice versa. They can be used as a component of sensors, actuators and generators. WO 2001/06575 A1 discloses, for example, an energy converter, its use and its production. The energy converter converts mechanical energy into electrical energy. Some of the energy converters shown contain prestressed polymers. The prestressing improves the conversion between electrical and mechanical energy. There is additionally disclosed a device which comprises an electroactive polymer for converting electrical energy into mechanical energy. There are further disclosed electrodes which are adapted to the form of the polymer in the energy converter. Processes for the production of an electromechanical device comprising one or more electroactive polymers are also disclosed.

The use of ferroelectret materials and in particular of polymer ferroelectrets has hitherto been described only in so-called thickness mode (d₃₃ mode). However, because of the much greater expansion which can theoretically be achieved, operation in planar mode (d₃₁ mode) would also be desirable. Such an operation would be of interest especially in the field of energy production.

In the conference paper “Three-layer ferroelectrets from perforated Teflon®-PTFE films fused between two homogeneous Teflon®-FEP films”, 2007 Annual Report Conference on Electrical Insulation and Dielectric Phenomena by H. C. Basso, R. A. P. Altafim, R. A. C. Altafim, A. Mellinger, Peng Fang, W. Wirges and R. Gerhard, a route to polymeric ferroelectrets with uniform voids is described. Two homogeneous Teflon®-FEP films are separated from one another by means of a Teflon®-PTFE film thermally bonded thereto. The Teflon®-PTFE film has a plurality of homogeneous holes. Closed voids with FEP bases and tops and PTFE walls are thus formed.

After charging the upper and lower FEP layers with positive and negative polarity, the voids form large dipoles, which can be deformed by mechanical or electrical action. Consequently, the three-layer sandwich exhibits direct and inverse piezoelectricity. The continuous method for joining the layers involves a press with heated cylinder rollers, which are operated at temperatures of up to 310° C. This permits the production of inexpensive converter materials on a large scale. The conference paper deals with the design, processing, charging and electromechanical properties of the three-layer ferroelectrets.

Layer composites of dielectric elastomers and other materials for electromechanical converters are disclosed in US 2009/0169829 A1. That patent application relates to a multilayer composite having a film, a first electrically conductive layer and at least one intermediate layer, which is arranged between the film and the first electrically conductive layer. The film is made of a dielectric material and has a first and a second surface. At least the first surface comprises a surface pattern with elevations and depressions. The first electrically conductive layer is attached to the surface pattern and has a wave shape, which is formed by the surface pattern of the film.

According to an embodiment of the invention described in that patent application, the intermediate layer can be obtained by plasma treatment of the film surface. The intermediate layer serves to improve the adhesion between the electrically conductive layer and the film.

International patent application WO 2008/076271 A1 provides a specific combination of electroactive polymers and piezoelectric polymers. That application describes an integrated sensor/actuator, which uses an electroactive polymer. The sensor/actuator comprises an actuator part of an ionic polymer/metal composite, a sensor part of a piezoelectric material, and an insulating part between the actuator part and the sensor part. The sensor/actuator can further have a compensation circuit for receiving a sensor signal from the sensor part and an actuator signal from the actuator part, which circuit compensates the received signal for coupling between the actuator part and the sensor part. However, the structure disclosed therein is not suitable for energy-producing operation in the superficial direction of the element.

The object underlying the present invention is to provide an electromechanical converter of the type mentioned at the beginning which is distinguished by the possibility of operation with greater expansions, in particular in the superficial direction.

The object is achieved according to the invention in that the converter comprises at least one dielectric elastomer layer, electrodes and at least one electret layer, wherein the dielectric elastomer layer is contacted by the at least one electret layer, wherein the at least one electret layer carries an electric charge and is contacted by a first electrode, and wherein a second electrode is arranged on the side of the dielectric elastomer layer opposite the first electrode.

The electromechanical converter according to the invention is based first on the general finding that the dielectric displacement (electric flux density), which is determinative for the operation of such a converter, can be changed by varying two parameters. The dielectric displacement can be given as the sum of the polarisation and the product of the electric field strength and the electric field constant:

\vec{D}=ε₀\vec{E}+\vec{P}

The fact that the second electrode is arranged on the side of the dielectric elastomer layer opposite the first electrode can mean that the elastomer layer is contacted by that electrode. It is, however, also possible for an electret layer or other layers to be located between the electrode and the elastomer layer.

An expansion or compression of the converter in the longitudinal or superficial direction causes a change in the electric field constant and/or the polarisation of the system. It is accordingly possible to operate the converter in planar mode (d₃₁ mode) in order to produce energy.

Compared with piezoelectric converters which are operated in planar mode and in which excursions in the per-thousand range are to be noted, the converter according to the invention can be operated with far greater expansions. For example, maximum expansions during operation of ≧10%, ≧20%, ≧30% or even ≧50% are conceivable. In that manner, new possibilities for the construction of more efficient electromechanical converters are obtained, for example.

The dielectric elastomer can have, for example, a maximum tension of ≧0.2 MPa and a maximum expansion of ≧100%. In the use expansion range up to ≦200%, the tension can be from ≧0.1 MPa to ≦50 MPa (determination according to ASTM D 412). The elastomer can further have a modulus of elasticity at 100% expansion of from ≧0.1 MPa to ≦100 MPa (determination according to ASTM D 412).

It is possible for the elastomer layer and/or the electret layer or electret layers to be compact in form. This is to be understood within the context of the present invention as meaning that the proportion of voids within the layers in question is from ≧0 vol % to ≦5 vol % and in particular from ≧0 vol % to ≦1 vol %.

It is further preferred for the elastomer layer and the electret layer or electret layers to be connected together over their extent. The nature of the connection can in particular be a material-based connection.

The nature of the contacting of the electret layer or electret layers with their associated electrodes is not specified further at this point and can take place, for example, at the side or over the surface. When the dielectric elastomer layer is contacted by an electret layer on opposing sides, sides of the electret layer facing and remote from the dielectric elastomer layer are formed in each case. It is preferred for the first electret layer to be contacted by the first electrode on its side remote from the dielectric elastomer layer.

The electrodes can further be structured. A structured electrode can be in the form of, for example, a conducting coating in strips or in lattice form. The sensitivity of the electromechanical converter can additionally be influenced thereby and adapted to specific applications. For example, the electrodes can be so structured that the converter has active and passive regions. In particular, the electrodes can be so structured that signals can be detected in a space-resolved manner or active regions can purposively be triggered. This can be achieved by providing the active regions with electrodes, while the passive regions do not have electrodes.

The thickness of the dielectric elastomer layer can be, for example, in a range of from ≧10 μm to ≦500 μm and preferably from ≧20 μm to ≦200 μm. The thickness of the first and/or further electret layers can be, for example, in a range of from ≧1 μm to ≦200 μm and preferably from ≧2 μm to ≦100 μm.

Embodiments of the invention are described below, it being possible for the individual embodiments to be combined with one another as desired, unless otherwise clearly apparent from the context.

In one embodiment of the electromechanical converter according to the invention, the dielectric elastomer layer is contacted on opposing sides by a first electret layer and a second electret layer, wherein the first electret layer and the second electret layer carry opposite electric charges and wherein the first electret layer is contacted by the first electrode and the second electret layer is contacted by the second electrode.

By expanding or compressing the converter in the longitudinal or superficial direction, the two differently charged electret layers are brought closer together or moved apart. Operation of the converter for energy production in planar mode (d₃₁ mode) is accordingly possible.

In a further embodiment of the electromechanical converter according to the invention, at least one of the sides of the dielectric elastomer layer has along at least one direction a wave-like cross-sectional profile with elevations and depressions.

Preferably, the side having along at least one direction a wave-like cross-sectional profile with elevations and depressions is at least one of the sides of the dielectric elastomer layer that is contacted by the first and/or, where present, second electret layer.

“Wave-like” is here to be understood as meaning a regular or irregular sequence of elevations and depressions. A regular sequence is preferred. The distance from one elevation to the adjacent elevation can be, for example, from ≧1 μm to ≦5000 μm and preferably from ≧5 μm to ≦2000 μm. The vertical distance between the deepest point of a depression and the highest point of an adjacent elevation can be, for example, from ≧0.3 μm to ≦5000 μm and preferably from ≧5 μm to ≦2000 μm.

An example of a wave-like profile along one direction is when, in an elastomer layer which has a thickness direction, a longitudinal direction and a transverse direction, the wave-like profile is formed only in the longitudinal direction. A further example is the case where that profile occurs in the longitudinal and transverse directions.

The advantage of a wave-like profile is that, when the elastomer layer expands in the direction of the waves, more material is available for the expansion.

It is advantageous for the wave-like profile of the side of the dielectric elastomer layer to be a sine wave profile or a triangular wave profile. These wave forms are to be so understood that any desired sine or triangular waves scaled vertically and/or horizontally can be used. Preference is given, however, to sine waves which obey the equation y=sin(x) and to triangular waves in which the vertex of the triangle forms a right angle.

In a further embodiment of the electromechanical converter according to the invention, the side contacted by the at least one electret layer and the side of the dielectric elastomer layer opposite that side have a wave-like cross-sectional profile with elevations and depressions along the same direction, and elevations and depressions of the profile of one side further run parallel to elevations and depressions of the profile of the other side of the dielectric elastomer layer. The thickness of the elastomer layer in the running direction of the waves can then remain as uniform as possible even in the case of a large expansion.

In a further embodiment of the electromechanical converter according to the invention, the at least one electret layer and/or at least the first electrode has/have along at least one direction a wave-like cross-sectional profile which is matched to the wave-like cross-sectional profile of the contacted side of the dielectric elastomer layer. In that manner, electret and/or electrode layers can readily adapt also to the expansion of the elastomer layer.

In a further embodiment of the electromechanical converter according to the invention, the dielectric elastomer layer comprises a polyurethane polymer, silicone polymer and/or acrylate polymer. Preference is given to polyurethane elastomers. These can be prepared by reaction of a polyisocyanate A) and/or a polyisocyanate prepolymer B) with at least one difunctional compound C) reactive towards isocyanate groups in the presence of a catalyst D) conventional in polyurethane chemistry.

There are suitable as the polyisocyanate A), for example, 1,4-butylene diisocyanate, 1,6-hexamethylene diisocyanate (HDI), isophorone diisocyanate (IPDI), 2,2,4- and/or 2,4,4-trimethylhexamethylene diisocyanate, the isomeric bis-(4,4′-isocyanatocyclohexyl)methanes or mixtures thereof of any desired isomer content, 1,4-cyclohexylene diisocyanate, 4-isocyanatomethyl-1,8-octane diisocyanate (nonane triisocyanate), 1,4-phenylene diisocyanate, 2,4- and/or 2,6-toluene diisocyanate, 1,5-naphthylene diisocyanate, 2,2′- and/or 2,4′- and/or 4,4′-diphenylmethane diisocyanate, 1,3- and/or 1,4-bis-(2-isocyanato-prop-2-yl)-benzene (TMXDI), 1,3-bis(isocyanatomethyl)benzene (XDI), alkyl 2,6-diisocyanatohexanoates (lysine diisocyanates) having alkyl groups with from 1 to 8 carbon atoms, as well as mixtures thereof Further suitable structural units of component A) are compounds that are based on the mentioned diisocyanates and contain a uretdione, isocyanurate, biuret, iminooxadiazinedione or oxadiazinetrione structure.

Component A) can preferably be a polyisocyanate or a polyisocyanate mixture having a mean NCO functionality of from 2 to 4 with solely aliphatically or cycloaliphatically bonded isocyanate groups. Preference is given to polyisocyanates or polyisocyanate mixtures of the above-mentioned type with a uretdione, isocyanurate, biuret, iminooxadiazinedione or oxadiazinetrione structure, as well as mixtures thereof, and a mean NCO functionality of the mixture of from 2 to 4, preferably from 2 to 2.6 and particularly preferably from 2 to 2.4.

The polyisocyanate prepolymers which can be used as component B) can be obtained by reaction of one or more diisocyanates with one or more hydroxy-functional, in particular polymeric, polyols, optionally with the addition of catalysts as well as auxiliary substances and additives. Furthermore, components for chain extension, such as, for example, with primary and/or secondary amino groups (NH₂- and/or NH-functional components), can additionally be used for the formation of the polyisocyanate prepolymer.

The polyisocyanate prepolymer of component B) can preferably be obtainable from the reaction of polymeric polyols and aliphatic diisocyanates. Hydroxy-functional, polymeric polyols for the reaction to form the polyisocyanate prepolymer B) can be, for example, polyester polyols, polyacrylate polyols, polyurethane polyols, polycarbonate polyols, polyether polyols, polyester polyacrylate polyols, polyurethane polyacrylate polyols, polyurethane polyester polyols, polyurethane polyether polyols, polyurethane polycarbonate polyols and/or polyester polycarbonate polyols. These can be used for the preparation of the polyisocyanate prepolymer on their own or in any desired mixtures with one another.

Suitable polyester polyols for the preparation of the polyisocyanate prepolymers B) can be polycondensation products of di- and optionally tri- and tetra-ols and di- and optionally tri- and tetra-carboxylic acids or hydroxycarboxylic acids or lactones. Instead of the free polycarboxylic acids, the corresponding polycarboxylic acid anhydrides or corresponding polycarboxylic acid esters of lower alcohols can also be used for the preparation of the polyesters.

Examples of suitable diols are ethylene glycol, butylene glycol, diethylene glycol, triethylene glycol, polyalkylene glycols such as polyethylene glycol, also 1,2-propanediol, 1,3-propanediol, 1,3-butanediol, 1,4-butanediol, 1,6-hexanediol and isomers, neopentyl glycol or hydroxypivalic acid neopentyl glycol ester or mixtures thereof, preference being given to 1,6-hexanediol and isomers, 1,4-butanediol, neopentyl glycol and hydroxypivalic acid neopentyl glycol ester. Polyols such as trimethylolpropane, glycerol, erythritol, pentaerythritol, trimethylolbenzene or trishydroxyethyl isocyanurate or mixtures thereof can also be used.

There can be used as dicarboxylic acids phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethylglutaric acid and/or 2,2-dimethylsuccinic acid. The corresponding anhydrides can also be used as the acid source.

Provided that the mean functionality of the polyol to be esterified is ≧2, monocarboxylic acids, such as benzoic acid and hexanecarboxylic acid, can in addition also be used concomitantly.

Preferred acids are aliphatic or aromatic acids of the type mentioned above. Adipic acid, isophthalic acid and phthalic acid are particularly preferred.

Hydroxycarboxylic acids which can be used concomitantly as reactants in the preparation of a polyester polyol having terminal hydroxyl groups are, for example, hydroxycaproic acid, hydroxybutyric acid, hydroxydecanoic acid or hydroxystearic acid or mixtures thereof Suitable lactones are caprolactone, butyrolactone or homologues or mixtures thereof Caprolactone is preferred.

It is also possible to use for the preparation of the polyisocyanate prepolymers B) hydroxyl-group-containing polycarbonates, for example polycarbonate polyols, preferably polycarbonate diols. For example, they can have a number-average molecular weight Mₙ of from 400 g/mol to 8000 g/mol, preferably from 600 g/mol to 3000 g/mol. They can be obtained by reaction of carbonic acid derivatives, such as diphenyl carbonate, dimethyl carbonate or phosgene, with polyols, preferably diols.

Examples of diols suitable for that purpose are ethylene glycol, 1,2- and 1,3-propanediol, 1,3- and 1,4-butanediol, 1,6-hexanediol, 1,8-octanediol, neopentyl glygol, 1,4-bishydroxymethylcyclohexane, 2-methyl-1,3-propanediol, 2,2,4-trimethyl-1,3-pentanediol, dipropylene glycol, polypropylene glycols, dibutylene glycol, polybutylene glycols, bisphenol A or lactone-modified diols of the above-mentioned type, or mixtures thereof.

The diol component preferably contains from 40 wt. % to 100 wt. % hexanediol, preferably 1,6-hexanediol, and/or hexanediol derivatives. Such hexanediol derivatives are based on hexanediol and can contain ester or ether groups in addition to terminal OH groups. Such derivatives are obtainable, for example, by reaction of hexanediol with excess caprolactone or by etherification of hexanediol with itself to form di- or tri-hexylene glycol. The amount of these and other components is so chosen that the sum does not exceed 100 wt. % and in particular is 100 wt. %.

Hydroxyl-group-containing polycarbonates, in particular polycarbonate polyols, are preferably of linear structure.

Polyether polyols can also be used for the preparation of the polyisocyanate prepolymers B). For example, there are suitable polytetramethylene glycol polyethers as are obtainable by polymerisation of tetrahydrofuran by means of cationic ring opening. Polyether polyols which are likewise suitable can be the addition products of styrene oxide, ethylene oxide, propylene oxide, butylene oxide and/or epichlorohydrin on di- or poly-functional starter molecules. There can be used as suitable starter molecules, for example, water, butyl diglycol, glycerol, diethylene glycol, trimethylolpropane, propylene glycol, sorbitol, ethylenediamine, triethanolamine or 1,4-butanediol or mixtures thereof.

Preferred components for the preparation of the polyisocyanate prepolymers B) are polypropylene glycol, polytetramethylene glycol polyether and polycarbonate polyols or mixtures thereof, polypropylene glycol being particularly preferred.

Polymeric polyols having a number-average molecular weight Mₙ of from 400 g/mol to 8000 g/mol, preferably from 400 g/mol to 6000 g/mol and particularly preferably from 600 g/mol to 3000 g/mol can be used. They preferably have an OH functionality of from 1.5 to 6, particularly preferably from 1.8 to 3, most particularly preferably from 1.9 to 2.1.

In addition to the mentioned polymeric polyols, short-chained polyols can also be used in the preparation of the polyisocyanate prepolymers B). For example, ethylene glycol, diethylene glycol, triethylene glycol, 1,2-propanediol, 1,3-propanediol, 1,4-butanediol, 1,3-butylene glycol, cyclohexanediol, 1,4-cyclohexanedimethanol, 1,6-hexanediol, neopentyl glycol, hydroquinone dihydroxyethyl ether, bisphenol A (2,2-bis(4-hydroxyphenyl)propane), hydrogenated bisphenol A (2,2-bis(4-hydroxycyclohexyl)propane), trimethylolpropane, trimethylolethane, glycerol or pentaerythritol or a mixture thereof can be used.

Also suitable are ester diols of the mentioned molecular weight range, such as α-hydroxybutyl-ε-hydroxy-caproic acid ester, ω-hydroxyhexyl-γ-hydroxybutyric acid ester, adipic acid (β-hydroxyethyl)ester or terephthalic acid bis(β-hydroxyethyl)ester.

Monofunctional isocyanate-reactive hydroxyl-group-containing compounds can also be used for the preparation of the polyisocyanate prepolymers B). Examples of such monofunctional compounds are ethanol, n-butanol, ethylene glycol monobutyl ether, diethylene glycol monomethyl ether, diethylene glycol monobutyl ether, propylene glycol monomethyl ether, dipropylene glycol monomethyl ether, tripropylene glycol monomethyl ether, dipropylene glycol monopropyl ether, propylene glycol monobutyl ether, dipropylene glycol monobutyl ether, tripropylene glycol monobutyl ether, 2-ethylhexanol, 1-octanol, 1-dodecanol or 1-hexadecanol or mixtures thereof.

For the preparation of the polyisocyanate prepolymers B), diisocyanates can preferably be reacted with the polyols at a ratio of the isocyanate groups to hydroxyl groups (NCO/OH ratio) of from 2:1 to 20:1, for example of 8:1. Urethane and/or allophanate structures can thereby be formed. A proportion of unreacted polyisocyanates can subsequently be separated off. Thin-layer distillation, for example, can be used for that purpose, there being obtained low-residual-monomer products having residual monomer contents of, for example, ≦1 wt. %, preferably ≦0.5 wt. %, particularly preferably ≦0.1 wt. %. The reaction temperature can be from 20° C. to 120° C., preferably from 60° C. to 100° C. Stabilisers such as benzoyl chloride, isophthaloyl chloride, dibutyl phosphate, 3-chloropropionic acid or methyl tosylate can optionally be added during the preparation.

NH₂- and/or NH-functional components can additionally be used for chain extension in the preparation of the polyisocyanate prepolymers B).

Suitable components for chain extension are organic di- or poly-amines. For example, ethylenediamine, 1,2-diaminopropane, 1,3-diaminopropane, 1,4-diaminobutane, 1,6-diaminohexane, isophoronediamine, isomer mixtures of 2,2,4- and 2,4,4-trimethylhexamethylenediamine, 2-methylpentamethylenediamine, diethylenetriamine, diaminodicyclohexylmethane or dimethylethylenediamine or mixtures thereof can be used.

It is additionally possible to use for the preparation of the polyisocyanate prepolymers B) also compounds which contain secondary amino groups in addition to a primary amino group, or OH groups in addition to an amino group (primary or secondary). Examples thereof are primary/secondary amines, such as diethanolamine, 3-amino-1-methylaminopropane, 3-amino-1-ethylaminopropane, 3-amino-1-cyclohexylaminopropane, 3-amino-1-methylaminobutane, alkanolamines such as N-aminoethylethanolamine, ethanolamine, 3-aminopropanol, neopentanolamine For chain termination there are conventionally used amines having an isocyanate-reactive group, such as methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl(methyl)aminopropylamine, morpholine, piperidine, or suitably substituted derivatives thereof, amidoamines of diprimary amines and monocarboxylic acids, monoketime of diprimary amines, primary/tertiary amines, such as N,N-dimethylaminopropylamine.

The polyisocyanate prepolymers, or mixtures thereof, used as component B) can preferably have a mean NCO functionality of from 1.8 to 5, particularly preferably from 2 to 3.5 and most particularly preferably from 2 to 3.

Component C) is a compound having at least two isocyanate-reactive functional groups. For example, component C) can be a polyamine or a polyol having at least two isocyanate-reactive hydroxy groups.

There can be used as component C) hydroxy-functional, in particular polymeric, polyols, for example polyether polyols or polyester polyols. Suitable polyols have already been described above in connection with the preparation of the prepolymer B) so that, in order to avoid repetition, reference is made thereto.

It is preferred for component C) to be a polymer having from 2 to 4 hydroxy groups per molecule, most particularly preferably a polypropylene glycol having from 2 to 3 hydroxy groups per molecule.

It is advantageous if the polymeric polyols C) have a particularly narrow molecular weight distribution, that is to say a polydispersity (PD=Mw/Mn) of from 1.0 to 1.5. Polyether polyols, for example, preferably have a polydispersity of from 1.0 to 1.5 and an OH functionality of greater than 1.9 and particularly preferably greater than or equal to 1.95.

Such polyether polyols can be prepared in a manner known per se by alkoxylation of suitable starter molecules, in particular using double metal cyanide catalysts (DMC catalysis). This method is described, for example, in patent specification U.S. Pat. No. 5,158,922 and Offenlegungsschrift EP 0 654 302 A1.

The reaction mixture for the polyurethane can be obtained by mixing components A) and/or B) and C). The ratio of isocyanate-reactive hydroxy groups to free isocyanate groups is preferably from 1:1.5 to 1.5:1, particularly preferably from 1:1.02 to 1:0.95.

Preferably at least one of components A), B) or C) has a functionality of ≧2.0, preferably of ≧2.5, preferably of ≧3.0, in order to introduce branching or crosslinking into the polymer element. In the case of components A) and B), the term “functionality” refers to the mean number of NCO groups per molecule, and in the case of component C) it refers to the mean number of OH groups per molecule. Such branching or crosslinking brings about better mechanical properties and better elastomeric properties, in particular also better expansion properties. The resulting polyurethane polymer can preferably have a maximum tension of ≧0.2 MPa, in particular from 0.4 MPa to 50 MPa, and a maximum expansion of ≧100%, in particular of ≧120%. Moreover, the polyurethane can have in the use expansion range up to ≦200% a tension of from 0.1 MPa to 50 MPa, for example from 0.5 MPa to 40 MPa, in particular from 1 MPa to 30 MPa (determination according to ASTM D 412). Furthermore, the polyurethane can have a modulus of elasticity at 100% expansion of from 0.1 MPa to 100 MPa, for example from 1 MPa to 80 MPa (determination according to ASTM D 412).

The resulting polyurethane polymer is preferably a dielectric elastomer having a volume resistivity according to ASTM D 257 of from ≧10¹² to ≦10¹⁷ ohms-cm. It is further preferred for the polyurethane polymer to have a dielectric breakdown voltage according to ASTM 149-97a of from ≧50 V/μm to ≦200 V/μm.

As well as containing components A), B), C) and D), the reaction mixture for the preparation of the polyurethane can also contain auxiliary substances and additives. Examples of such auxiliary substances and additives are crosslinkers, thickeners, solvents, thixotropic agents, stabilisers, antioxidants, light stabilisers, emulsifiers, surfactants, adhesives, plasticisers, hydrophobising agents, pigments, fillers and flow aids. Preferred solvents are methoxypropyl acetate and ethoxypropyl acetate. Preferred flow aids are polyacrylates, in particular amine-resin-modified acrylic copolymers.

Fillers can regulate the dielectric constant of the polymer element, for example. The reaction mixture preferably comprises fillers for increasing the dielectric constant, such as fillers having a high dielectric constant. Examples thereof are ceramics fillers, in particular barium titanate, titanium dioxide and piezoelectric ceramics such as quartz or lead zirconate titanate, as well as organic fillers, in particular those having a high electric polarisability, for example phthalocyanines.

A high dielectric constant can additionally be achieved by the incorporation of electrically conductive fillers below the percolation threshold. Examples thereof are carbon black, graphite, single-wall or multi-wall carbon nanotubes, electrically conductive polymers such as polythiophenes, polyanilines or polypyrroles, or mixtures thereof Of interest in this context are in particular those carbon black types which have surface passivation and therefore increase the dielectric constant at low concentrations below the percolation threshold and nevertheless do not lead to an increase in the conductivity of the polymer.

It should be noted that the term “a” in connection with the present invention and in particular with components A), B) and C) is not used as a numeral but as an indefinite article, unless a different interpretation is clearly apparent from the context.

In a further embodiment of the electromechanical converter according to the invention, the material of the dielectric elastomer layer has a dielectric constant εᵣ of ≧2. The dielectric constant can also be in a range of from ≧2 to ≦2000 or from ≧3 to ≦1000. The determination of that constant can be carried out according to ASTM 150-98.

In a further embodiment of the electromechanical converter according to the invention, at least one electret layer comprises a polymer selected from the group comprising polycarbonates, perfluorinated or partially fluorinated polymers and copolymers, polytetrafluoroethylene (PTFE), fluoroethylenepropylene (FEP), perfluoroalkoxyethylene (PFA), polyester, polyethylene terephthalate (PET), polyethylene naphthalate (PEN), polyimide, polyether imide, polyether, polymethyl(meth)acrylate, cycloolefin polymers, cycloolefin copolymers (COC), polyolefins, polypropylene and mixtures of those polymers. If more than one electret layer is present, the same applies correspondingly to that layer too. The preferred material is FEP.

In a further embodiment of the electromechanical converter according to the invention, the material of at least the first electrode is selected from the group comprising metals, metal alloys, conductive oligomers or polymers, conductive oxides, and/or polymers filled with conductive fillers. If a second electrode is present, the same also applies correspondingly thereto. As conductive oligomers or polymers there can be used, for example, polythiophenes, polyanilines or polypyrroles. As fillers for polymers filled with conductive fillers there can be used, for example, metals, materials based on conductive carbon, such as carbon black, carbon nanotubes (CNTs), or conductive oligomers or polymers. The filler content of the polymers is preferably above the percolation threshold so that the conductive fillers form continuous electrically conductive paths within the polymers filled with conductive fillers.

In a further embodiment of the electromechanical converter according to the invention, the thickness ratio between the dielectric elastomer layer and the at least one electret layer is in a range of from ≧1:1 to ≦100:1. The thickness ratios are in each case indicated for the thickness of the elastomer layer and of an electret layer and can also be in a range of from ≧2:1 to ≦50:1.

The present invention relates further to a process for the production of an electromechanical converter according to the invention, comprising the steps:
(a1) providing a dielectric elastomer layer;
(b1) contacting the dielectric elastomer layer with a first electret layer;
(c1) electrically charging the arrangement obtained previously so that the first electret layer carries an electric charge;
(d1) contacting the first electret layer with a first electrode; and
(e1) arranging a second electrode on the side of the dielectric elastomer layer opposite the first electrode.

In this process according to the invention, the order of the steps, and in particular of steps (b1) and (c1), is not fixed from the outset. It is, for example, also possible that after (c1) first (b1) and then (d1) and (e1) are carried out.

The provision of the dielectric elastomer layer can advantageously take place directly from a roll, so that a “roll-to-roll” process is permitted. For the same considerations, that can also be carried out for the electret layers.

Contacting of the elastomer layer with the electret layers can be achieved, for example, by lamination at elevated temperatures. A firm connection between the individual layers can thus be formed.

Alternatively, solvent-based or extrusion and coextrusion processes can also be used in the steps described above.

The two electret layers are so charged that they carry mutually opposite electric charges. This can take place, for example, by means of tribocharging, electron beam bombardment, application of an electric voltage to already existing electrodes, or corona discharge. In particular, charging can take place by means of a two-electron corona arrangement. The needle voltage can be ≧20 kV, ≧25 kV and in particular ≧30 kV. The charging time can be ≧20 seconds, ≧25 seconds and in particular ≧30 seconds. Corona treatment can advantageously also be carried out successfully on a large scale.

The electret layers can be contacted with the electrodes by means of conventional processes such as sputtering, spraying, vapour deposition, chemical vapour deposition (CVD), printing, doctor blade application and spin coating.

When arranging the second electrode on the side of the dielectric elastomer layer opposite the first electrode, the same procedure can in principle be used. It is possible for the elastomer layer to be contacted by the second electrode. However, it is also possible for an electret layer, for example, to be located between the second electrode and the elastomer layer, which electret layer is then correspondingly contacted.

The present invention further provides the use of an electromechanical converter according to the invention as an actuator, sensor or generator. The use can be, for example, in the electromechanical and/or electroacoustic field. In particular, electromechanical converters according to the invention can be used in the field of energy production from mechanical vibrations (energy harvesting), acoustics, ultrasound, medical diagnostics, acoustic microscopy, mechanical sensor technology, in particular pressure, force and/or expansion sensor technology, robotics and/or communications technology, in particular in loudspeakers, vibration transducers, light deflectors, membranes, modulators for fibre optics, pyroelectric detectors, capacitors and control systems.

The present invention relates likewise to an actuator, sensor or generator comprising an electromechanical converter according to the invention. In order to avoid unnecessary lengthy passages, reference is made with regard to the details and specific embodiments to the above comments in connection with the converter.

The present invention likewise provides a method for obtaining electrical energy, comprising the steps:
(a2) providing a generator element, wherein the generator element has a longitudinal direction and a thickness direction and comprises at least one electret layer arranged in the longitudinal direction or a plurality of opposing electret layers arranged in the longitudinal direction,
   wherein there is an electric charge separation within an electret layer in the thickness direction of the generator element, and this electret layer is contacted by electrodes on opposing sides in the thickness direction, or
   wherein an electret layer carries an electric charge and this electret layer is contacted by electrodes on opposite sides in the thickness direction, or
   wherein an electret layer carries an electric charge and a further electret layer carries an electric charge which is different or the same, and these electret layers are each contacted by an electrode;
(b2) expanding the generator element along the longitudinal direction and deriving electric charge from the electrodes; and
(c2) relaxing the generator element along the longitudinal direction and deriving electric charge from the electrodes.

The method according to the invention for obtaining electrical energy starts from the finding that a generator element is operated in planar mode (d₃₁ mode). In the simplest case, the generator element is a sufficiently thick electret layer in which there is a macroscopic electric charge separation along its thickness and which can be connected by means of electrodes to a suitable electric circuit. It is likewise possible for an electrically charged electret layer contacted by electrodes on both sides to be present.

A further simple case is that two identically or differently charged and spatially separate, superimposed electret layers are present.

The generator element is expanded along its longitudinal direction. Expansion can also generally be carried out in the superficial direction. On expansion, the relative spacing of the electrodes preferably changes, as a result of which a charge displacement occurs in the case of a symmetrical construction of the generator. However, it is also possible in the symmetrical case that the surface area of opposing electret layers will change, leading to a dielectric displacement. The resulting electric voltage is derived from the electrodes and can be used. When the generator element is relaxed, the reverse process takes place.

In an embodiment of this method according to the invention, the generator element is an electromechanical converter as described above. In order to avoid unnecessary lengthy passages, reference is made with regard to details and specific embodiments to the above comments in connection with the converter.

The invention is explained further by means of the following drawings, but without being limited thereto. In the drawings:

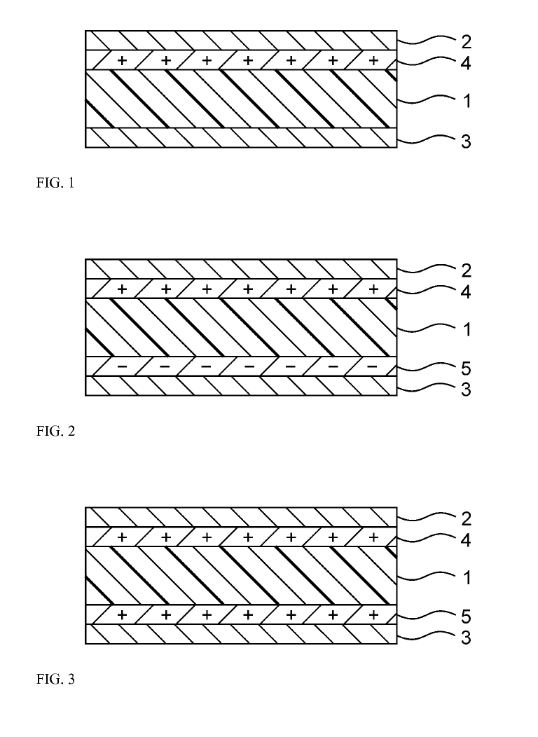

FIG. 1 shows an electromechanical converter

FIG. 2 shows a further electromechanical converter

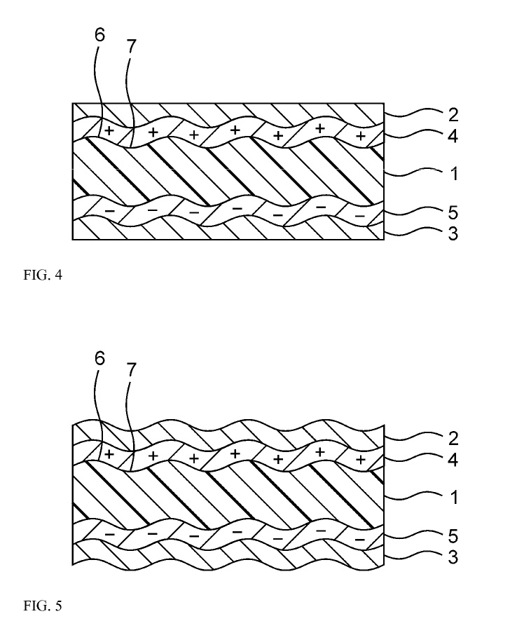

FIG. 3 shows a further electromechanical converter

FIG. 4 shows a further electromechanical converter

FIG. 5 shows a further electromechanical converter.

FIG. 1 shows an electromechanical converter in a cross-sectional view. It can be the cross-sectional view of a laminate film. The thickness direction of this arrangement runs vertically in the drawing and the longitudinal direction runs horizontally.

A dielectric elastomer layer 1 is contacted on its upper side by a first electret layer 4. The electric charge of these electret layers is shown schematically by the symbol “+”. This can be achieved during production of the converter in a corona discharge process. On the side of the electret layer 4 remote from the dielectric elastomer layer 1 there is arranged the first electrode 2. The second electrode 3 is located on the side of the dielectric elastomer layer remote from the electret layer 4.

When the converter expands in the longitudinal direction there is a reduction in its thickness. Because the distance between the electret layer 4 and the first electrode 2 remains constant during expansion but the distance of the electret layer 4 to the second electrode 3 changes, a piezoelectric effect occurs. The electric voltage that is produced thereby can be tapped by means of the electrodes 2 and 3.

FIG. 2 shows a further electromechanical converter in a cross-sectional view. For example, this can also be the cross-sectional view of a laminate film. The thickness direction of this arrangement runs vertically in the drawing and the longitudinal direction runs horizontally.

A dielectric elastomer layer 1 is contacted on its upper side and on the opposite lower side by first electret layer 4 and second electret layer 5. The opposing electric charges of the two electret layers 4, 5 are shown schematically by the symbols “+” and “−”. This can be achieved during production of the converter in a corona discharge process by suitable positioning of the electrodes.

Sides of the electret layers 4, 5 facing and remote from the dielectric elastomer layer 1 are formed by the position of the electret layers 4, 5. The first electrode 2 is located on the side of the first electret layer 4 remote from the elastomer layer 1. Correspondingly, the second electrode 3 is located on the side of the second electret layer 5 remote from the elastomer layer 1.

When the converter expands in the longitudinal direction, there is a contraction in the thickness direction. This results in the oppositely charged electret layers 4 and 5 being brought closer together. When there is a relaxation in the longitudinal direction, the electret layers 4 and 5 move apart again. The electric voltage that occurs due to the piezoelectric effect can be tapped by means of the electrodes 2 and 3.

FIG. 3 shows a variation of the electromechanical converter shown in FIG. 2. The two electret layers 4, 5 now have the same, positive electric charge. Naturally, those layers can also be negatively charged. When the converter expands in the longitudinal direction, a piezoelectric effect occurs here too owing to the change in the size of the opposing faces.

FIG. 4 shows a further variation of the electromechanical converter shown in FIG. 2. Here, the dielectric elastomer layer 1 has a wave-like cross-sectional profile along the longitudinal direction. In the present case, the wave-like cross-section is formed on sides of the elastomer layer 1 contacted by both electret layers 4, 5. The wave-like cross-sectional profile has elevations 6 and depressions 7. The elevations 6 and depressions 7 of the upper and lower side of the elastomer layer 1 run parallel. This has the advantage that the thickness of the elastomer layer 1 in the longitudinal direction remains as uniform as possible in the case of a large expansion in the longitudinal direction.

The electret layers 4, 5 likewise have on both sides a wave-like cross-sectional profile, which is matched to the profile of the elastomer layer 1. Here too, the behaviour in the case of large expansions in the longitudinal direction is advantageous. The sides of the electrodes 2, 3 contacting the electret layers 4, 5 are matched in their cross-sectional profile to the wave-like profile of the electret layers 4, 5.

FIG. 5 shows a variation of the electromechanical converter shown in FIG. 4. The electrodes 2, 3 contacting the electret layers 4, 5 have on their upper and lower sides a wave-like profile matched to that of the electret layers 4, 5. The cross-sectional profile of the converter as a whole has here been optimised to the thickness behaviour in the case of high degrees of expansion.

1. An electromechanical converter, wherein the converter comprises at least one dielectric elastomer layer, electrodes and at least one electret layer,
wherein the dielectric elastomer layer is contacted by the at least one electret layer,
wherein the at least one electret layer carries an electric charge and is contacted by a first electrode, and
wherein a second electrode is arranged on a side of the dielectric elastomer layer opposite the first electrode.

2. An electromechanical converter according to claim 1, wherein the dielectric elastomer layer is contacted on opposite sides by a first electret layer and a second electret layer,
wherein the first electret layer and the second electret layer carry opposite electric charges, and
wherein the first electret layer is contacted by the first electrode and the second electret layer is contacted by the second electrode.

3. An electromechanical converter according to claim 1, wherein at least one side of the dielectric elastomer layer has along at least one direction a wave-like cross-sectional profile with elevations and depressions.

4. An electromechanical converter according to claim 3, wherein a side contacted by the at least one electret layer and a side of the dielectric elastomer layer opposite thereto have a wave-like cross-sectional profile with elevations and depressions along the same direction, and wherein elevations and depressions of the profile of one side further run parallel to elevations and depressions of the profile of the other side of the dielectric elastomer layer.

5. An electromechanical converter according to claim 3, wherein the at least one electret layer and/or at least the first electrode has along at least one direction a wave-like cross-sectional profile which is matched to a wave-like cross-sectional profile of a contacted side of the dielectric elastomer layer.

6. An electromechanical converter according to claim 1, wherein the dielectric elastomer layer comprises a polyurethane polymer, silicone polymer and/or acrylate polymer.

7. An electromechanical converter according to claim 1, wherein material of dielectric elastomer layer has a dielectric constant εr of ≧2.

8. An electromechanical converter according to claim 1, wherein at least one electret layer comprises a at least one polymer selected from the group consisting of polycarbonates, perfluorinated or partially fluorinated polymers and copolymers, polytetrafluoroethylene (PTFE), fluoroethylenepropylene (FEP), perfluoroalkoxyethylene (PFA), polyester, polyethylene terephthalate (PET), polyethylene naphthalate (PEN), polyimide, polyether imide, polyether, polymethyl(meth)acrylate, cycloolefin polymers, cycloolefin copolymers (COC), polyolefins, and polypropylene.

9. An electromechanical converter according to claim 1, wherein material of at least the first electrode is at least one selected from the group consisting of metals, metal alloys, conductive oligomers or polymers, conductive oxides, and polymers filled with conductive fillers.

10. An electromechanical converter according to claim 1, wherein a thickness ratio between the dielectric elastomer layer and the at least one electret layer is in a range of from ≧1:1 to ≦100:1.

11. A process for production of an electromechanical converter according to claim 1, comprising:
(a1) providing a dielectric elastomer layer;
(b1) contacting the dielectric elastomer layer with a first electret layer;
(c1) electrically charging an arrangement obtained previously so that the first electret layer carries an electric charge;
(d1) contacting the first electret layer with a first electrode; and
(e1) arranging a second electrode on the side of the dielectric elastomer layer opposite the first electrode.

12. An electromechanical converter according claim 1 capable of being used as an actuator, sensor or generator.

13. An actuator, sensor or generator comprising an electromechanical converter according to claim 1.

14. A method of obtaining electrical energy, comprising:
(a2) providing a generator element, wherein the generator element has a longitudinal direction and a thickness direction and comprises at least one electret layer arranged in the longitudinal direction or a plurality of opposing electret layers arranged in the longitudinal direction,
wherein there is an electric charge separation within an electret layer in a thickness direction of the generator element, and said electret layer is contacted by electrodes on opposing sides in the thickness direction, or
wherein an electret layer carries an electric charge and said electret layer is contacted by electrodes on opposite sides in the thickness direction, or
wherein an electret layer carries an electric charge and a further electret layer carries an electric charge which is different or the same, and said electret layers are each contacted by an electrode;
(b2) expanding the generator element along the longitudinal direction and deriving electric charge from the electrodes; and
(c2) relaxing the generator element along the longitudinal direction and deriving electric charge from the electrodes.

15. A method according to claim 14, wherein the generator element is an electromechanical converter according to claim 1.
